(19) United States
(12) Patent Application Publication
(10) Pub. No.: US 2007/0036101 A1
(43) Pub. Date: Feb. 15, 2007

(54) Distributed node B module

(76) Inventors: Fumin Chen, Shenzhen (CN); Xufan She, Shenzhen (CN); Jianzhong Ma, Shenzhen (CN)

Correspondence Address: LADAS & PARRY LLP, 224 SOUTH MICHIGAN AVENUE, SUITE 1600, CHICAGO, IL, 60604, US

(21) Appl. No.: 11/451,957

(22) Filed: Jun. 13, 2006

(30) Foreign Application Priority Data
Aug. 15, 2005 (CN) 200520063228.1

(51) Int. Cl. H04Q 7/00

(52) U.S. Cl. 370/328; 379/428.01; 455/575.1

(57) ABSTRACT

The present invention discloses a distributed Node B module which is used for containing a remote radio unit of a distributed Node B. Said module includes a roughly cuboid module body, an outlet chamber arranged at one lateral side of the module body, and a plurality of outlet connectors arranged at the bottom side of which module body. The present invention employs a combination of the bottom outlet connectors and the lateral outlet chamber, which makes a reasonable utilization of the structure, increases the density of outlets in a better way. In the case of equivalent outlet density, the volume and the weight of the module can be decreased, and the networking becomes more convenient and flexible.

### FIELD OF THE INVENTION

The present invention relates to the field of wireless communication. More particularly, it relates to a distributed Node B module that can be installed outdoors.

### BACKGROUND OF THE INVENTION

As mobile networks are expanded continuously, the selecting of an installation site for a Node B becomes a bottleneck during building mobile network. No matter which way is used, i.e. to share a co-location with 2 G or to select a new station, it becomes increasingly difficult, and the cost thereof becomes higher and higher. While 80% traffic of mobile networks comes from crowded city zones. Distributed Node Bs being used widely somewhat solve this problem.

A distributed Node B consists of a Base Band Unit (BBU) for performing the base band processing and a Remote Radio Unit (RRU) for performing the radio frequency processing. The BBU and the RRU may be installed or arranged separately, and be connected to each other through electrical or optical interfaces, thus to form a configuration of distributed Node B.

Wherein the RRU is an outdoor remote radio module, which is directly installed on a metal mast or a wall near an antenna in general. Therefore, a distributed Node B module which is used to contain the RRU is desired to be small, light, and convenient during building mobile network. Additionally, in view of the requirement that the RRU is used in the field in some cases, the distributed Node B module is desired to be with good waterproof performance.

### SUMMARY OF THE INVENTION

The present invention aims at providing a distributed Node B module used for containing a RRU of a distributed Node B, comprising a module body, an outlet chamber arranged at a lateral side of the module body, and a plurality of outlet connectors arranged at the bottom or top side of said module body.

Preferably, there is a concave portion arranged adjacent said outlet chamber.

Preferably, the distributed Node B module of the present invention further comprises a handle arranged in said concave portion.

Preferably, said handle is located at the outside of said outlet chamber.

Preferably, there is a groove arranged corresponding to said handle.

Preferably, said groove is arranged on the inner edge of the other lateral side.

Preferably, said outlet connectors are waterproof connectors.

Preferably, said outlet chamber is provided with a waterproof cable-pressing unit.

Preferably, the distributed Node B module of the present invention further comprises a handle arranged adjacent said outlet chamber on said module body.

Preferably, there is a grasping space arranged corresponding to said handle.

Compared with the prior art, the present invention employs a combination of the bottom/top outlet connectors and the lateral outlet chamber, which makes a reasonable utilization of the structure, increases the density of outlets in a better way. In the case of equivalent outlet density, the volume and the weight of the module can be decreased, and the networking becomes more convenient and flexible.

In a preferred embodiment of the present invention, the outlet connectors employ waterproof connectors, and/or the outlet chamber is provided with a waterproof cable-pressing structural member, thus the distributed Node B module has a waterproof performance suitable for field application situation.

Furthermore, based on the structural feature of the lateral outlet chamber, a handle is arranged at a lateral side of the distributed Node B module, which may reduce the volume of the module as a whole. Further more, a grasping space, such as a groove, is arranged at the other lateral side, which facilitates a handling manipulation during module operations and improves the space utility.

### BRIEF DESCRIPTION OF THE DRAWINGS

FIG. 1 is a structural schematic diagram of a distributed Node B module according to an embodiment of the present invention.

FIG. 2 is a structural schematic diagram of the distributed Node B module according to an embodiment of the present invention observed from another view.

FIG. 3 is a structural schematic diagram of the distributed Node B module according to an embodiment of the present invention observed from yet another view.

### DETAILED DESCRIPTION OF THE EMBODIMENTS

The embodiment of the present invention will be described in more details with reference to the accompanying figures.

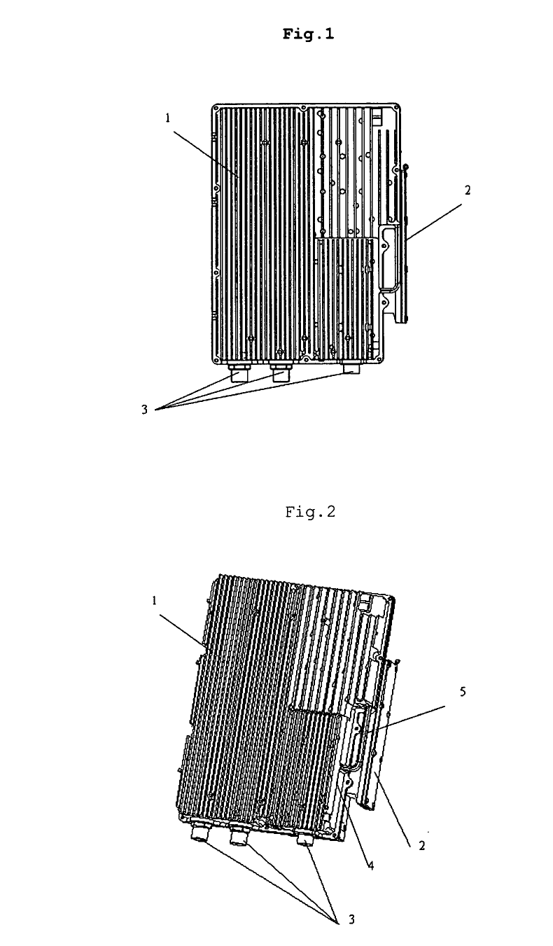

FIG. 1 to FIG. 3 show a distributed Node B module according to an embodiment of the present invention. Said distributed Node B module, being used to contain a RRU, is usually installed on a metal mast or on a wall outdoors or in the field.

As shown in FIG. 1, the distributed Node B module includes a roughly cuboid module body 1 which is used to contain a RRU of a distributed Node B. A rectangular outlet chamber 2, which is waterproof, is arranged at the right side of the module body 1. Three waterproof outlet connectors 3 are arranged at the bottom of the body. Both the outlet chamber and the outlet connectors are used for outlets.

Said rectangular waterproof outlet chamber 2 is provided with a waterproof cable-pressing structural member (not shown).

It should be understood that said right side and said bottom side etc. mentioned above are viewed from the front side of drawings, and are only used for illustrative purpose. In practice, the position of the outlet chamber 2 and the outlet connectors 3 may be arbitrary arranged, depending on the actual situation. For example, the outlet connectors 3 may be arranged at the top side of the module body 1. It should also be understood that the three waterproof outlet connectors 3 are used for illustrative purpose, but not for limiting the present utilization model. In practice, there can be one or more such waterproof outlet connectors.

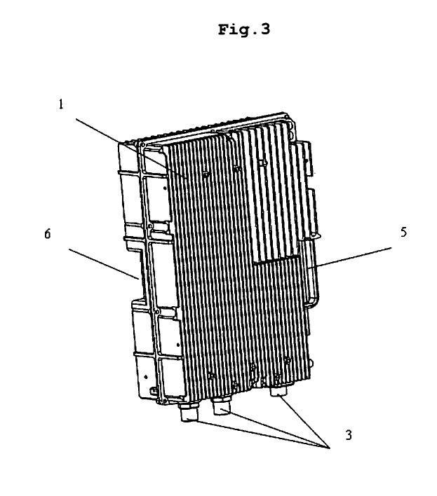

Referring to FIG. 2, a concave portion 4 is arranged adjacent the waterproof outlet chamber 2. A arc-like handle 5 is arranged in the concave portion 4, on which handle 5 can be fixed or hinged. The handle 5 is positioned at the outside of the waterproof outlet chamber 2.

Referring to FIG. 3, a groove 6 is arranged on the inner edge at the left side of the module body 1, serving as a grasping space. The groove 6 corresponds to the handle 5 so as to facilitate manipulations, for example, to facilitate the carrying of the module 1 over a short distance. Of course, a person skilled in the art can understand that the grasping space may adopt other shapes or structures, the location of which corresponds to that of the handle 5 so as to facilitate manipulations.

Both the bottom and the lateral sides are utilized for outlets in the present invention so that the density of outlets is increased. In the case of equivalent outlet density, the volume and the weight of the module can be decreased, and thus the networking becomes more convenient and flexible. Furthermore, a handle is arranged in the space adjacent the lateral outlet structure, and a grasping space is provided at the back side (the term “back side” is given with respect to the drawings, used for illustrative purpose, but not for limiting the present invention), which facilitates a handling manipulation during operating of the module and improves the space utility.

1. A distributed Node B module for containing a RRU, comprising a module body,
an outlet chamber, arranged at one lateral side of said module body; and
a plurality of outlet connectors, arranged at the bottom or top side of said module body.

2. The distributed Node B module according to claim 1, wherein there is a concave portion arranged adjacent said outlet chamber.

3. The distributed Node B module according to claim 2, further comprising a handle arranged in said concave portion.

4. The distributed Node B module according to claim 3, wherein said handle is located at the outside of said outlet chamber.

5. The distributed Node B module according to claim 4, wherein there is a groove arranged corresponding to said handle.

6. The distributed Node B module according to claim 5, wherein said groove is arranged on the inner edge of the lateral side that is opposite to the lateral side at which said handle is arranged.

7. The distributed Node B module according to claim 1, wherein said outlet connectors are waterproof connectors.

8. The distributed Node B module according to claims 1, wherein said outlet chamber is provided with a waterproof cable-pressing unit.

9. The distributed Node B module according to claim 1, further comprising a handle, which is arranged adjacent said outlet chamber on said module body.

10. The distributed Node B module according to claim 15, wherein there is a grasping space arranged corresponding to said handle.
